(19) United States
(12) Patent Application Publication
(10) Pub. No.: US 2011/0147042 A1
(43) Pub. Date: Jun. 23, 2011

(54) ELECTRICAL CABLE AND INSULATING COMPOSITION POLYETHYLENE BASED RESISTANT TO TRACKING

(75) Inventors: Sergio Arturo Montes Valdez, Monterrey (MX); Héctor Ricardo López González, Saltillo (MX)

(73) Assignee: CONDUCTORES MONTERREY, S.A. DE C. V., San Nicolas de los Garza (MX)

(21) Appl. No.: 12/973,771

(22) Filed: Dec. 20, 2010

(30) Foreign Application Priority Data
Dec. 21, 2009 (MX) MX/A/2009/014225

(51) Int. Cl. H01B 7/17; H01B 3/46; C08K 5/5419

(52) U.S. Cl. 174/113 R; 174/110 SR; 524/269

(57) ABSTRACT

An insulating composition resistant to tracking for an electrical cable, wherein the insulating composition comprises a polymer matrix based on polyethylene or its copolymers, with a density of at least 0.94 g/cm³, and including no more than 0.25% by weight of silicone oil respect to the total weight of said composition.

### TECHNICAL FIELD OF THE INVENTION

This invention relates to the field of insulating compositions for electrical cables, and more precisely, to an insulating composition resistant to tracking that incorporates a very small amount of silicone oil to a polymer matrix based on polyethylene; it also refers to an electrical cable incorporating an insulating coating with said composition.

### BACKGROUND OF THE INVENTION

The power distribution cables suitable for installation along high voltage overhead lines of so-called compact lines must present in their insulating coating high resistant to degradation, and finally the phenomenon called tracking. This is also the case of the overhead distribution cables fitted with insulation, commonly referred to as semi-isolated.

An insulating material subject to the combined action of an electrical gradient and external agents (humidity, solar radiation, pollutants, etc.) suffers degradation due to the phenomenon known as tracking. This is the situation affecting the material that forms the outer coating of an electrical cable suspended close to an overhead medium voltage line. The gradient applied is the difference between the potential of the electrical field around the cable and the grounding, which is connected via cable clamps that attach it to the support towers or support. Close to the clamps, the insulating material is subject to the maximum variation of the electrical field.

When the electrical cable is dry, the high resistance surface of the coating prevents the flow of current, and consequently there is no evidence of degradation. Exposure to atmospheric elements, and in particular to solar radiation, causes an oxidation of the surface of the material that increases its affinity for water. When the coating starts to retain water, and together with this, air pollutants, reduces the surface resistance drastically, and thus current flows through the water film lining the coating. This current flow produces, through the Joule effect, a local heating of the material together with water evaporation. The situation becomes critical when the coating is only partially wet, so that the wet areas with low electrical resistance alternate with dry areas with much greater resistance. The high conductivity gradient at the points of separation between dry and wet areas leads to the formation of electrical discharges that heat strongly the underlying coating, with subsequent degradation of the polymer material and the formation of cracks and erosion areas that extend rapidly until breaking the material. In the case of polyolefin materials, degradation is manifested by an initial melting followed by oxidation with a consequent increase in the local wettability and therefore the number of electrical shocks, so as to cause the ignition of the polymer, which shows in the form of tracking, which increases locally the electrical conductivity, which in turn accelerates the degradation process.

The electrical cables used in power distribution lines of the so-called compact lines and so-called semi-insulated wires, require insulation that is resistant to tracking, has good mechanical properties and is resistant to ultraviolet radiation, so that light cables may be produced, resistant to mechanical tensions. One of the most important mechanical properties is the resistance to abrasion, which, in the case of polyethylenes depends basically on the density of the polymer.

The U.S. Pat. No. 4,673,247 describes cables that are suitable in particular for installation close to overhead high voltage lines, and which have an outer coating consisting of a polymeric material (for example, a vinyl ethylene-acetate copolymer) in an hydroxide mixture, for example, zinc hydroxide, magnesium hydroxide or, preferably, aluminum hydroxide in amounts corresponding between 30% to 60% by weight, and more preferably in approximately 50% by weight.

To obtain a tracking resistance combined with satisfactory mechanical properties, the international patent application WO-93/05424 describes a cable in which the outer coating is formed by a composition consisting of linear polyethylene, preferably linear medium density polyethylene (LMDPE), mixed, if necessary, with ramified low density polyethylene (LDPE) that consists of 15% to 30% by weight of magnesium hydroxide or aluminum hydroxide.

The high amount of metal hydroxide present in the present embodiments described above does not only have an effect on the protection against fire, but also makes it possible to increase the resistance of the polymer to the phenomena of tracking, but inevitably leads to a deterioration of mechanical properties in terms of the module and elongation of the rupture, and also to a considerable increase of the density, and as a consequence of the total weight of the cable per length unit.

It is also possible to have insulations resistant to tracking using polyolefins without a high concentration of inorganic fillers such as metal hydroxides. The U.S. Pat. No. 2,976,344 describes the use of polyethylene as insulation in compact lines. The patent U.S. Pat. No. 4,426,549 describes polyethylene and similar polyolefins as materials highly resistant to tracking, mentioning also that the use of additives normally used in these materials, usually deteriorates their resistance to carbonation. Japanese Patent JP-9092035 describes a tracking resistant cable consisting of a mixture of low density polyethylene (LDPE) and linear low density polyethylene (LLDPE), said mixture having a density of 0.915 g/cm³ to 0.932 g/cm³, moreover being crosslinkable for moisture. The patent also discloses that the use of lubricants based on fluorinated compounds and silicone increase resistance to tracking. Said Japanese patent does not mention which are the specific characteristics of the silicone compounds to produce a beneficial effect on resistance to tracking.

The U.S. Pat. No. 3,300,576 describes the use of high density polyethylene made with a small amount of black smoke as an absorber of ultraviolet light in the manufacture of accessories of compact lines, which have the same functional requirements as the cables described in this invention, that is, high resistance to tracking, good mechanical properties, and a proper resistance to ultraviolet radiation.

Therefore, a need to provide a composite high strength insulation to tracking, which is resistant to abrasion and reduces the use of metal hydroxides, for which the applicant has found it possible to produce an electrical cable with an insulation coating that presents optimum mechanical properties as well as high resistance to tracking, by means of the application of an optimum amount of silicone oil to the polymer composition of the outer coating consisting of a polyethylene or its copolymers with a minimum density of 0.94 g/cm³.

### SUMMARY OF THE INVENTION

In view of the above mentioned and the purpose of providing solutions to the constraints encountered, it is the object of the invention to provide an insulating composition resistant to tracking for an electrical cable, wherein the composition comprises a polymer matrix based on polyethylene or its copolymers with a density of at least 0.94 g/cm³, and no more than 0.25% by weight of silicone oil respect to the total weight of the composition.

It is also the object of this invention to provide an electrical cable resistant to tracking formed by at least one electrical conductor and at least one thermoplastic insulation to tracking composed by a polymer matrix based on polyethylene or its copolymers with a density of at least 0.94 g/cm³, and no more than 0.25% by weight of silicone oil respect to the total weight of the composition.

### BRIEF DESCRIPTION OF THE DRAWINGS

The characteristic details of the present invention are described in the following paragraphs, together with the figures related to it, in order to define the objectives of this invention, but not limiting the scope of it.

FIG. 1 illustrates a sectional perspective view of an electrical cable insulation resistant to carbonation according to the invention.

### DETAILED DESCRIPTION OF THE INVENTION

The characteristic details of this invention are described in the following paragraphs, which have the objective of defining the invention, but without limiting its scope.

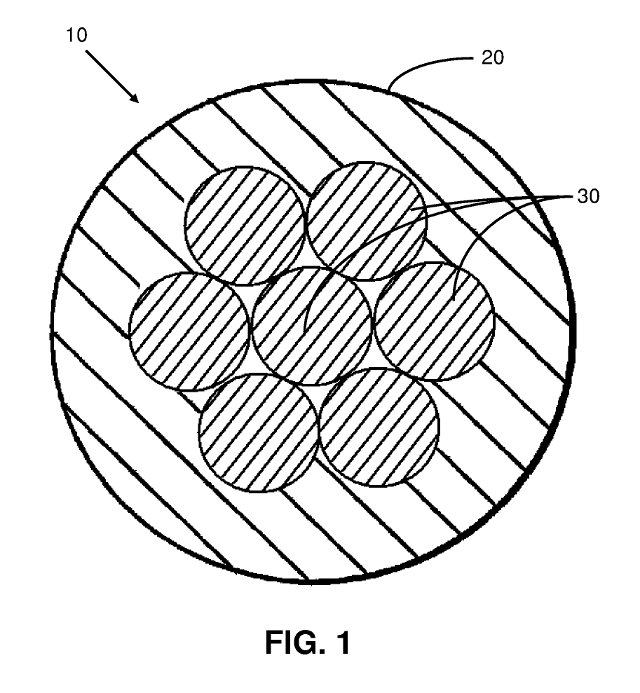

In FIG. 1, illustrating an electrical cable 10 comprising one or more conductors 20 and one or more insulating coatings 30, wherein at least the most outer coating comprises an insulating composition resistant to the tracking according to the invention. FIG. 1 shows only one possible embodiment of an electrical cable according to the present invention. It is clear that appropriate modifications can be made known in the art in this embodiment without leaving the scope of the present invention.

The insulating composition resistant to tracking according to the invention shows compounds which in turn may consist of multiple components.

The components are described individually below, without necessarily being described in any order of importance.

### Compound I: Polymer Matrix Based on Polyethylene

The thermoplastic composition resistant insulation to tracking of the invention contains a polymer matrix consisting of a homopolymer, copolymer or polymer mixture with polyethylene, low density polyethylene medium (LDPE), medium density polyethylene (MDPE), high density polyethylene (HDPE) or combinations of the former, as long as the density is higher than 0.94 g/cm³.

### Compound II: Silicone Oil

The thermoplastic composition resistant insulation to tracking of the invention contains one or more silicone oils, in particular polydimethylsiloxane, dimethylsiloxane, alkylsiloxane, phenylsiloxane, chlorosilanes as well as silicone emulsions formed by methyl-dimethyl-silicon, alkylsiloxane, arylsiloxane and chlorosilanes that by their chemical characteristics contribute to low surface tension, excellent water repellence, high temperature stability and good lubrication. Preferably polydimethylsiloxane is used with a viscosity of 50×10⁻⁶ m²/s (50 centistokes) at a temperature of 20° C.

The applicant has found that concentrations no more than 0.25% by weight relative to the weight of the polymer matrix based on polyethylene resistance to tracking of the insulating thermoplastic composition is significantly improved.

### Other Compounds

Optionally, to the polymer matrix based on polyethylene other known compounds can be added, such as flame retardants, antioxidants, inhibitors of degradation, processing aids, pigments and the like, in varying amounts that can be readily determined by persons skilled in the art according to the specific requirements of application.

Flame retardants, can be selected from inorganic oxides in hydrate or hydroxide form. Examples of suitable compounds are the oxides of aluminum, bismuth, cobalt, iron, magnesium, titanium or zinc and the corresponding hydroxides or mixtures thereof. Preferred are magnesium hydroxide, aluminium hydroxide and aluminium trihydrate or mixtures thereof whether natural, synthetic or synthetic modified. It is possible to add, advantageously, one or more oxides or inorganic salts such as CoO, TiO₂, Sb₂O₃, ZnO Fe₂O₃, CaCO₃ or mixtures thereof to these compounds in small quantities.

Appropriate conventional antioxidants are, for example, polymerized trimethyl dihydroquinoline, 4,4′-Thiobis(3-methyl-6-tert-butylphenol), pentaerythritol[3-(3,5-di-tercbutyl-4-hydroxyphenyl)propionate], 2,2′-thio-ethylene-bis[3-(3,5-di-tert-butyl-4-hydroxyphenyl)propionate], pentaerythritol tetra kis[3-(3,5-di-tert-butyl-4-hydroxyphenyl)propionate] and the like, or mixtures thereof.

Other fillers that can be used in the invention include, for example, glass particles, glass fibers, calcined kaolin, talc and the like, or mixtures thereof.

Processing aids are, for example, calcium stearate, zinc stearate, stearic acid, paraffin wax, and the like or mixtures thereof.

### Mixture and Application

Typically, the thermoplastic composition of the insulation resistant to tracking of the invention is prepared by mixing the polymer matrix based on polyethylene, with silicone oil and suitable additives according to conventional procedures, for of the type of a dual spindle. The polymer mixture thus example, in an internal mixer of the type with tangential rotors, intercalated rotors, or in other mixers of the continuous type or obtained is subsequently used to coat one or more electrical conductors by extrusion.

The thermoplastic composition insulation resistant to tracking resistant insulating compounds mentioned above in the following concentrations by weight percent:
(a) from 99.75% to 99.99% by weight of polymer matrix based on polyethylene or its copolymers with a density of at least 0.94 g/cm³, and
(b) no more than 0.25% by weight of silicone oil.

### Examples of Embodiments of the Invention

The invention will now be described with respect to the following examples, which are solely for the purpose of representing the way of carrying out the implementation of the principles of the invention. The following examples are not intended as a comprehensive representation of the invention, nor try to limit the scope thereof.

Three moisture-induced crosslinking polyethylenes, designated as medium density (XLPE-MD-1 and XLPE-MD-2) and high density (XLPE-AD) and designed to be resistant to ultraviolet (UV) and tracking, were prepared according to the following formulations in percentage by weight according to Table 1:

TABLE 1

| | Commercial | XLPE- | XLPE- | XLPE- |
|---|---|---|---|---|
| Chemical component | name | MD-1 | MD-2 | AD |
| Low density poly(ethylene- | HFDA-5451 | 62.6 | 64.5 | — |
| co-silane) | from Dow | | | |
| | Chemical | | | |
| Medium density | ME4425 from | — | — | 59.7 |
| poly(ethylene-co-silane) | Borealis | | | |
| High density polyethylene | DGDK-3364 | 28.9 | 28.9 | 27.9 |
| | from Dow | | | |
| | Chemical | | | |
| Tin catalyst | DFDB-5480 | — | 2.9 | 4.8 |
| | from Dow | | | |
| | Chemical | | | |
| Fast curing catalyst | DFDA-5488 | 4.8 | — | — |
| | from Dow | | | |
| | Chemical | | | |
| White Concentrate (f) | 050-WT-307 | 3.1 | 3.1 | 3.1 |
| | from Polyone | | | |
| Black Concentrate | 055-BK-306 | 0.1 | 0.1 | 0.1 |
| | from Polyone | | | |
| Ultraviolet Stabilizer | Chimasorb 944 | 0.5 | 0.5 | 0.5 |
| | from Ciba | | | |
| Total | | 100.0 | 100.0 | 100.0 |
| Density, g/cm³ | | 0.941 | 0.940 | 0.949 |
| Classification according to | | Type III | Type II | Type III |
| ASTM D1248 | | | | |

The hydrophobic agents used were:
1. Silicone oil consisting of a polydimethylsiloxane with a viscosity of 50×10⁻⁶ m²/s (50 centistokes) at a temperature of 20° C. With this additive compounds of XLPE-AD are prepared compounds with concentrations of 0.06%, 0.12%, 0.24% and 0.48% by weight.
2. Silicone rubber consisting of a polydimethylsiloxane modified with vinyl groups, with a nominal hardness of 60 Shore A units, which corresponds to the classification VMQ described in Standard ASTM 1418. Product SE 6060 of supplier Momentive Performance Materials was used without adding any vulcanizing agent. This material was mixed with XLPE-AD at a rate of 0.69%, 1.39% and 2.78% by weight.
3. Technical grade oleamide is a material with a purity of 98%, an acid number less than 3 and a melting point between 66° C. and 72° C. This material was added to XLPE-MD-1 at a concentration of 0.48% by weight.
4. Technical grade erucamide is a material with a purity of 99%, an acid number less than 3 and a melting point between 79° C. and 85° C. This material was added to XLPE-MD-1 at a concentration of 0.48% by weight.
5. Technical grade stearamide is a material with an acid number less than 9 and a melting point between 98° C. and 104° C. This material was added to XLPE-MD-1 at a concentration of 0.48% by weight.

The mixtures of XLPE-MD-1, XLPE-MD-2 and XLPE-AD with hydrophobic agents were prepared using Brabender Plasticorder mixer 2000 equipped with a camera of the rotor type with a capacity of 60 cm³, and a mixing temperature of 140° C.

### Measurements

The evaluation of the resistance to tracking was carried out following the procedures established in Standard ASTM D2303 in its Section of Tracking Voltage. Samples were prepared with the following dimensions: 130 mm long, 50 mm wide and 6.1 mm thick by compression molding using a mold temperature of 140° C. and a time of 10 minutes. At the end of this period, the mold was cooled under pressure until the press plates temperature reached 80° C. The samples were crosslinked by absorbing water immersion product of such samples in a water bath at 90° C. for 8 hours, followed by a period of conditioning at room temperature for at least 24 hours prior to the test of resistance to tracking. For each run the tracking voltage was determined of 4 specimens being reported the average value thereof.

In a first study the effect of the addition of three hydrophobic agents of amide type was investigated on the tracking voltage of the crosslinkable low density polyethylene. The results are shown in Table 2, which shows that the addition of 0.48% by weight of any of these three hydrophobic agents deteriorates the resistance to tracking of XLPE-MD-1.

TABLE 2

| | | Average |
|---|---|---|
| Example | Material | (kV) |
| 1 | XLPE-MD-1 | 3.75 |
| 2 | XLPE-MD-1 + 0.48% oleamide weight | 3.50 |
| 3 | XLPE-MD-1 + 0.48% erucamide weight | 3.38 |
| 4 | XLPE-MD-1 + 0.48% stearamide | 3.50 |
| | weight | |

In a second study the effect of the addition of two hydrophobic agents, of silicone oil and stearamide was investigated in the tracking voltage of another crosslinkable low density polyethylene. The results are shown in Table 3, which shows that the addition of 0.48% by weight of any of these two hydrophobic agents deteriorates the resistance to tracking of XLPE-BD.

TABLE 3

| | | Run 1 | Run 2 | Average |
|---|---|---|---|---|
| Example | Material | (kV) | (kV) | (kV) |
| 5 | XLPE-MD-2 | 3.75 | 3.75 | 3.75 |
| 6 | XLPE-MD-2 + 0.48% | 3.50 | 3.25 | 3.38 |
| | stearamide weight | | | |
| 7 | XLPE-MD-2 + 0.48% | 3.25 | 3.25 | 3.25 |
| | silicone oil weight | | | |

Subsequently the effect of a compound of high molecular weight silicone was investigated in the resistance to tracking of a vulcanizable polyethylene of medium density (XLPE-MD). As described above, silicone rubber of the VMQ type was added in a wide range of concentrations. The results are shown in Table 4, which shows that the addition of silicone rubber also deteriorates the resistance to tracking of the XLPE-MD when adding it in concentrations of up to 2.88% by weight.

TABLE 4

| | Silicone rubber, % | Run 1 | Run 2 | Average |
|---|---|---|---|---|
| Example | of weight | (kV) | (kV) | (kV) |
| 8 | 0.00 | 3.50 | 3.50 | 3.50 |
| 9 | 0.72 | 3.00 | 3.25 | 3.13 |
| 10 | 1.44 | 3.00 | 3.25 | 3.13 |
| 11 | 2.88 | 3.25 | 3.25 | 3.25 |

In a result in accordance with the invention, it was found that using lower concentrations than 0.25% by weight of said silicone oil, resistance to tracking of the vulcanizable medium density polyethylene (XLPE-MD) increases significantly. The results, shown in Table 5 indicate that this increase in resistance to tracking reaches a maximum effect when the concentration is 0.12% and decreases at concentrations of about 0.24%. When the concentration of silicone oil is higher than the order of 0.48%, carbonation resistance further decreases, as shown by data from Example 7, shown in Table 3.

TABLE 5

| | Silicone oil, | Run 1 | Run 2 | Average |
|---|---|---|---|---|
| Example | % of weight | (kV) | (kV) | (kV) |
| 12 | 0.00 | 3.50 | 3.50 | 3.50 |
| 13 | 0.06 | 3.75 | 3.75 | 3.75 |
| 14 | 0.12 | 3.75 | 4.00 | 3.88 |
| 15 | 0.24 | 3.75 | 3.75 | 3.75 |

Based on the above, it can be considered in the case of silicone rubber that the combination of high molecular weight and its incompatibility with polyethylene compounds of the type used in this invention, cause the formation of two clearly distinct phases: a continuous phase formed by the compound of polyethylene and a discontinuous phase formed by the silicone rubber. Under these conditions it can be concluded that even though this phase discontinuous non-crosslinkable silicone rubber has some hydrophobic effect, its intrinsic resistance to tracking could be lower than the polyethylene compound, and therefore cause the resistance to tracking of the material to diminish. This is likely also to be the case with silicone oil at high concentrations. However, when the concentration of silicone oil is very small, it can be concluded that this material would be located in a more homogeneous way in the vulcanizable polyethylene amorphous phase without forming a continuous phase. This low concentration of silicone oil is enough to migrate to the surface of the material, by virtue of its incompatibility with polyethylene compounds, and causing the desired hydrophobic effect. Even when the effect presented in this invention has been shown in crosslinkable polyethylene compounds, it is anticipated that in the case of thermoplastic polyethylene compounds and its copolymers, the beneficial effect is also present in very low concentrations of silicone oil.

Based on the embodiments described above, it is contemplated that modifications of the embodiments described, as well as of the alternative embodiments, it will be considered obvious to a person skilled in the art of the technique under this description. Therefore, it is considered that the claims coating said alternative modifications that are within the scope of the present invention or its equivalents.

1. An insulating composition resistant to tracking for an electrical cable, wherein the insulating composition comprises a polymer matrix based on polyethylene or its copolymers, wherein said insulating composition is characterized in that the polyethylene compound or its copolymers have a density of at least 0.94 g/cm³, and includes no more than 0.25% by weight of silicone oil respect to the total weight of said composition.

2. The insulation composition according to claim 1, characterized in that the polymer matrix based on polyethylene is selected from a group consisting of polyethylene, low density polyethylene, medium density polyethylene, high density polyethylene, and combinations thereof.

3. The insulation composition according to claim 1, characterized in that the silicone oil is polydimethylsiloxane.

4. The insulation composition according to claim 3, characterized in that the polydimethylsiloxane has a viscosity of 50×10⁻⁶ m²/s (50 centistokes) at a temperature of 20° C.

5. The insulation composition according to claim 1, characterized in that it contains no more than 0.12% by weight of silicone oil.

6. An electrical cable resistant to tracking which comprises:
at least one electrical conductor, and
at least one thermoplastic coating resistant to tracking comprising a polymer matrix based on polyethylene;
and wherein said electrical cable is characterized in that said insulation cover including a polyethylene compound or its copolymers with a density of at least 0.94 g/cm³, and no more than 0.25% by weight of silicone oil respect to the total weight of said composition.

7. The electrical cable according to claim 6, characterized in that the polymer matrix based on polyethylene is selected from a group consisting of polyethylene, low density polyethylene, medium density polyethylene, high density polyethylene, and combinations thereof.

8. The electrical cable according to claim 6, characterized in that the silicone oil is polydimethylsiloxane.

9. The electrical cable according to claim 8, characterized in that the polydimethylsiloxane has a viscosity of 50×10⁻⁶ m²/s (50 centistokes) at a temperature of 20° C.

10. The electrical cable according to claim 6, characterized in that it contains no more than 0.12% by weight of silicone oil.
